(19) United States
(12) Patent Application Publication
(10) Pub. No.: US 2012/0186117 A1
(43) Pub. Date: Jul. 26, 2012

(54) Open/closed sign(s)

(76) Inventor: Ronald Edward Manning, Costa Mesa, CA (US)

(21) Appl. No.: 12/787,264

(22) Filed: Jan. 21, 2011

(51) Int. Cl. G09F 13/00; G09F 7/00

(52) U.S. Cl. 40/541; 40/584

(57) ABSTRACT

The purpose of this invention is to allow one to determine is a sign is an “open” sign or a “closed” sign from a greater distance than would be possible if one had to rely on the ability to read said sign. By incorporating the colors “red” and “green” the sign's written message doesn't have to be read.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING

“Not Applicable”

### BACKGROUND OF INVENTION

Existing open/closed signs can be hard to read when the signs are small.

### BRIEF SUMMARY OF INVENTION

This invention, by having OPEN sign be predominantly “Green” and the CLOSED sign be predominantly “Red” allows one to determine if it is an open or closed sign from a greater distance.

### BRIEF DESCRIPTION OF VIEWS OF DRAWING

“Not Applicable”

### DETAILED DESCRIPTION OF THE INVENTION

This invention, by having OPEN sign to be predominantly “Green” allows one to determine it is an open sign from a greater distance. This may be accomplished with green lettering, green background, green lighting, or any other means causing the sign to appear “Green”.

This invention, by having the CLOSED sign be predominantly “Red”: allows one to determine it is a closed sign from a greater distance. This may be accomplished with red lettering, red background, red lighting, or any other means causing the sign to appear “Red”.

This invention may consist of one or more signs. Predominantly “green” sign(s) signifying “Open” and predominantly “red” sign(s) signifying: Closed”.

### DRAWINGS

“Not Applicable”

This design patent is for open/closed signs.

Here are the claims:

1. OPEN sign to have green lettering or green background, or be predominantly green.

2. OPEN sign could be green with no lettering.

3. CLOSED sign to have red lettering or red background, or be predominantly red.

4. CLOSED sign could be red with no lettering

5. OPEN/CLOSED sign may be one sign with one side predominantly green (OPEN) and the other side being predominantly red (CLOSED).

6. OPEN sign may be one sign being predominantly green on both sides.

7. CLOSED sign may be one sign being predominantly red on both sides.

8. Signs may be made from any material acceptable for signage.

9. Red and Green color may be obtained using any acceptable coloring agent for signage.

10. Signs may be lighted or unlit.

11. Signs may appear green or red by use of lighting.
